(19) United States
(12) Patent Application Publication
(10) Pub. No.: US 2003/0160689 A1
(43) Pub. Date: Aug. 28, 2003

(54) Seat belt detection device

(76) Inventor: Darius Yazdgerdi, Vacaville, CA (US)

Correspondence Address: William S. Bernheim, 255 N. Lincoln St., Dixon, CA, 95620, US

(21) Appl. No.: 10/081,687

(22) Filed: Feb. 25, 2002

(51) Int. Cl. B60Q 1/00

(52) U.S. Cl. 340/457.1; 340/425.5

(57) ABSTRACT

An apparatus provides visible warning to a vehicle's driver, other drivers and law enforcement when an vehicle's occupant remains unbuckled in a car seat.

### BACKGROUND OF THE INVENTION

1. Field of the Invention

This invention relates to vehicular seat belts and similar safety harnesses and restraint apparatuses and a system for notifying the driver and law enforcement of the lack of proper deployment of the seat belt or similar safety harness or other restraint apparatus.

2. Description of the Prior Art

Seat belts, various safety harnesses, restraint apparatuses and other suitable restraint devices [hereinafter “seat belt(s)”] are known for the safe and proper restraint of an occupant within a seat deployed within an automobile.

However, despite the existence of laws designed to ensure proper use of seat belts for all occupants of a vehicle, thousands of persons lose their lives each year due to lack of use of their seat belt. Thousands more suffer serious and permanent injury. Sadly, children are all too often not properly restrained by responsible parties, even in child safety seats deployed within the vehicle. Due to their small size and frailty, children offer suffer the most from collisions and impacts which adults are able to more readily tolerate. Most of the deaths and injuries incurred by unsecured automobile occupants, including children seated within or without a suitable child safety seat, are simply avoided if proper use is made of seat belts.

Law enforcement officials are tasked with the serious job of enforcing laws requiring the use of seat belts, especially for the sake of those children dependent upon others to properly secure them within and fasten their seat belt for them. However, due to the difficulty of detection of the seat belt position of most occupants with today's modern automobiles, especially Sport Utility Vehicles, and also due to the almost impossibility of inspection of seat belt use while driving during low visibility conditions such as darkness or fog, these life saving laws are not readily enforceable by law enforcement officers. The impacts of such difficulty of enforcement include more injuries resultant of inadequate seat belt use, and lowered state and local revenues from violations not cited.

None of the existing systems teaches a maximally reliable method of notifying law enforcement officers, driving and outside the vehicle of the occupants being inspected, that all individuals within the automobile are properly, and lawfully, secured by proper use of their respective seat belts.

Therefore, it can be appreciated that there exists a continuing need for a new and improved system and apparatus for the safe transport of vehicle occupants and ready signaling to law enforcement officials of the lack of proper seat belt use and deployment for all occupants within a vehicle, especially those occupants dependent, for whatever reason, on others to fasten their seatbelts for them.

### SUMMARY OF THE INVENTION

In view of the foregoing disadvantages inherent in the prior art, the seat belt safety lights of the present invention departs substantially from the conventional designs and concepts of the prior art. In doing so it provides an apparatus primarily developed for the purpose of permitting safe transport of individuals, including children in baby car seats, and a reliable alert in the event the individual including a child is improperly secured in the vehicle via detection of a signal indicative of an occupant not secured by a fastened seat belt. As such, the general purpose of the present invention is to provide a seat belt safety lights and alert system which has all the advantages associated with combining the benefits of current seat belts and baby car seats, and has none of the disadvantages.

To attain this, the invention provides an apparatus for warning when an occupant, including a child, is positioned within a seat of a vehicle, including within a baby car seat disposed within the vehicle, and when the occupant's seat belt is not fastened. The apparatus includes an occupant detection mechanism for detecting the presence of an occupant, including a child, within a seat of the vehicle, including within a baby car seat located within the vehicle; a latch state detection mechanism for detecting the state of a seat belt latch of the seat upon which is located the occupant(s) of the vehicle; a control unit for generating an alarm signal when (i) the occupant detection mechanism detects the presence of an occupant within a seat, including with an infant seat, and (ii) the latch state detection mechanism detects that the state of the seat belt latch is not in the latched, or “closed” position; and alarm units for generating an alarm or alarms in response to the alarm signal. Said alarms preferably include lights visible to an outside viewer, such as a driving law enforcement official.

It is an object of the present invention to provide an effective method and system for indication and notification of the secured or unsecured transport state of occupants of seats disposed within vehicles, including children seated within baby car seats disposed within vehicles, that provides an alarm and/or alert permitting ready detection by driving law enforcement officials of an unsecured occupant within a vehicle.

These and other objects and advantages will be apparent to those skilled in the art in light of the following disclosure, claims and accompanying drawings.

### BRIEF DESCRIPTION OF THE DRAWINGS

FIG. 1 is a perspective illustration of a car seat including seat belt and seat belt latch for use in a vehicle in accordance with the present invention.

FIG. 2 is a side view of a rear window alarm light remote unit in accordance with the present invention.

FIG. 3 is a block diagram illustrating the connection of a control unit to various components of the car seat of the present invention, including connection to components of the vehicle within which is disposed the car seat of FIG. 1, connection to components of the car seat of FIG. 1 and connection to components of the rear window alarm light remote unit of FIG. 2.

### DESCRIPTION OF THE PREFERRED EMBODIMENTS

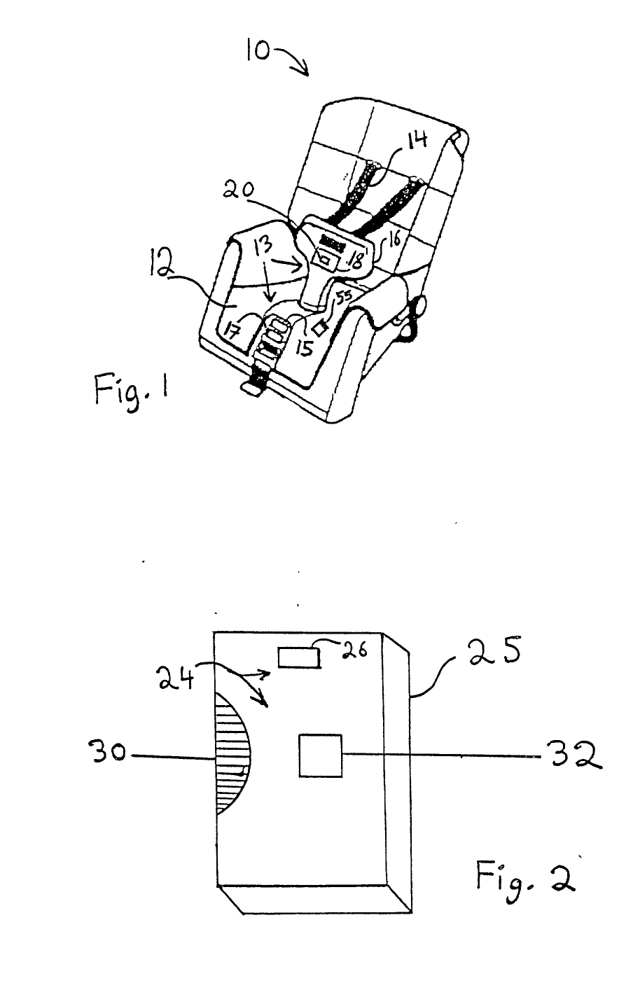

FIG. 1 illustrates a car seat 10 in accordance with the present invention including a seat 12 and a seat belt 14. In the instant case, car seat 10 is a baby car seat, as may be designed for infants, toddlers, or other children as needed. However, car seat 10 may be any suitable car seat disposed within the vehicle, whether a driver or passenger seat, a permanent car seat, or a removable car seat. Although not specifically illustrated, the car seat has a frame adapted to be fastened into place within an automobile in a conventional manner. Alternatively, the car seat may include a base unit fixedly attached to the vehicle and capable of cooperatively coupling to a car seat component unit including seat 12 and seat belt 14. In other embodiments, the car seat may be permanently affixed to the vehicle.

The car seat 10 includes a buckle mechanism 13 having clasp 15 and buckle housing 16 incorporated into harness 14, and a wired or wireless occupant state detector 18. Occupant state detector 18 further includes a control unit 22 and a latch state sensor 17 cooperatively coupled with buckle mechanism 13 in such a fashion and configuration as to permit the detection of the “OPEN” or “CLOSED” state of buckle mechanism 13, corresponding, respectively, to the “UNLATCHED” or “LATCHED” state of buckle mechanism 13, and thus of the seat belt 14. The occupant state detector 18 further preferably includes an occupant detector 55 incorporated into and located within or about the seat 12 of car seat 10. Occupant state detector 18 may include and employ any suitable means for detecting the presence of an occupant within the car seat 10. However, it is preferred that occupant detector 55 include a weight sensor located within or beneath the seat 12 of car seat 10 and designed and configured to detect the weight of an occupant. The occupant state detector 18 further includes a power source such as a battery preferably the vehicle's battery, and indicated by power unit 31, and an occupant state transmitter 33, and a voice generator 23 coupled to control unit 22, for which further reference is made to FIG. 3.

Upon the detection of weight upon the seat 12 of car seat 10 occupant detector 55 generates and sends along a wire or wirelessly to control unit 22 an “OCCUPANT” signal indicative of the presence of an occupant within car seat 10, for which reference is made to FIG. 3. Upon receiving the “OCCUPANT” signal control unit 22 is designed and configured to necessarily receive a “LATCH” signal from latch state detector 17 within a first predetermined interval of time, for example thirty seconds. At this point, in the absence of the receipt of such a “LATCH” signal from latch state detector 17 within the first predetermined interval of time, control unit 22, having sensed that seat belt 14 remains unbuckled, preferably activates at one light and preferably two to so indicate and generates an alarm to remind the vehicle driver that there is an unbuckled seat belt, providing the driver opportunity to know about and remedy the problem, before harm is incurred, or a citation provided. Preferably there are three lights, a first light on the dashboard of the driver to inidcate an unbuckled seat belt and two exterior lights that if green indicates occupied seats which are all buckled and if blue indicates that seats are occupied but belts unbuckled.

Thus, greater opportunity for safety is provided. For example, the alarm unit 27 controlled by control unit 22 generates an audible voice instructing the driver about at least one unbuckled seat belt.

However, should control unit 22 fail to receive the “LATCH” signal from latch state detector 17 within a second pre-determined interval of time, say one minute from receipt of the original “OCCUPANT” signal from occupant detector 55, at this point control unit 22, having sensed that the unbuckled state of seat belt 14 remains uncorrected, and thus having sensed the unsecured state of the seat occupant, activates occupant state transmitter 33 to send periodic pulses by wire or wireless to occupant state activation receiver 32 of rear window alarm light remote 25, that provides a “UNSECURED OCCUPANT” signal to second control unit 21 indicating to second control unit 21 that the car seat 10 is (i) occupied by a child, and that (ii) the seat belt 14 has not been latched. Upon receiving the “UNSECURED OCCUPANT” signal, second control unit 21, having sensed that the seat belt is delinquently unbuckled while the seat is occupied, preferably activates its alarm unit 19 to energize light 30 with a distinct flashing light.

Only by deliberate resetting of occupant state transmitter 18, such as may be accomplished by pushing activation buttons a preordained number of times, or in a preordained sequence, can control unit 22 be stimulated to send a signal to de-activate alarm unit 19 and light 30, and also a signal to occupant state detector 18 to cease sending a “UNSECURED OCCUPANT” signal to second control unit 21. When second control unit 21 ceases to receive the “UNSECURED OCCUPANT” signal, it deactivates its alarm unit 19.

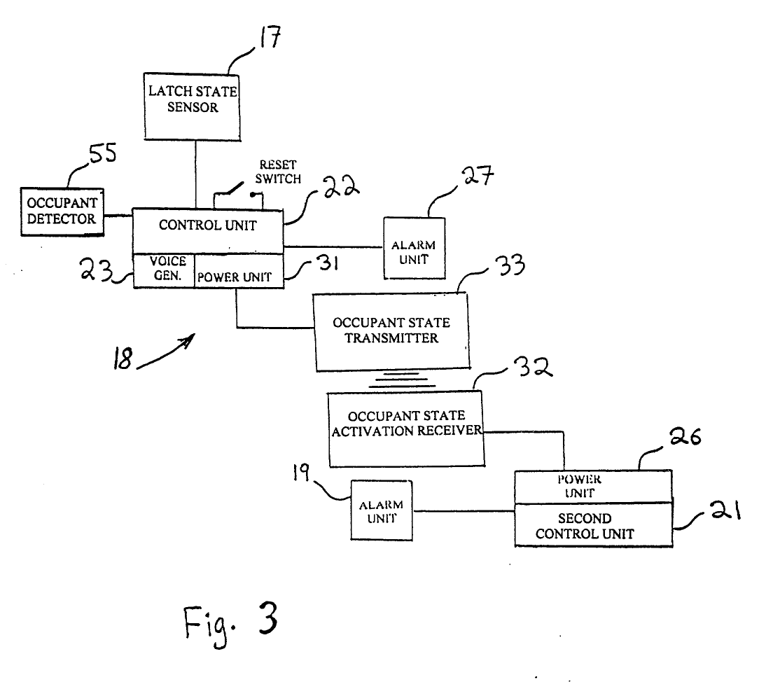

Shown in FIG. 2 is rear window alarm light remote 25 including an operations package 24. Rear window alarm light remote 25 is designed and configured in accordance with the present invention. More specifically, operations package 24 includes second control unit 21 (see FIG. 3), a power unit 26 having a battery, preferalbly the vehicles' battery with an access door, an alarm unit 19 (see FIG. 3) powered by the battery with light 30, and an occupant state activation receiver 32 also powered by the battery. Further, second control unit 21, and control unit 22 (see FIG. 3) can be implemented utilizing programmed general purpose processors, application specific processors, firmware and discrete components or combinations thereof. Rear window alarm light remote 25 also includes adhesive strips, suction cups or other suitable attachment means (not shown) for connection to the rear window of the automobile. Similarly, the light remote 25 could be incorporated into the building of the vehicle and incorporated in the bumper or rear deck and make use of the vehicle's battery.

Due to the easy implementation of portability of control units 22 and 21, and respectively occupant state detector 18 and rear window alarm light remote 25, the seat belt safety light alert apparatus and system of the present invention may be deployed into any automobile without requiring an integrated on board control unit.

The embodiment in the drawings illustrates a wireless connection between transmitter 33 of wireless occupant state detector 18 and second control unit 21, facilitating ease of installation. For example, sonic or RF may be suitably employed. Resultantly, the foregoing objects of the present invention have been attained. Hard wiring is preferred as the system should last the life of the vehicle.

Although the present invention has been shown and described with respect to preferred embodiments thereof, it should be understood by those skilled in the art that various changes and omissions in the form and detail thereof may be made therein without departing from the spirit and scope of the invention as defined in the appended claims.

I claim:

1. An apparatus for the notification and alert of drivers and law enforcement officials of the presence of an unsecured occupant of an automobile comprising:
(a) an occupant state detector for determining the presence of an unsecured individual disposed upon a car seat located within the automobile including:
(i) a latch state sensor for detecting the state of a seat belt latch of a seat belt associated with the car seat and capable of being activated by an unbuckled seat belt;
(ii) an occupant detector for detecting the presence of a individual seated within the car seat and activated if the seat is occupied; and
(iii) an alarm light visible from outside the vehicle and activated if the sensor is activated and the occupant detector is activated.

2. An apparatus for the notification and alert of drivers and law enforcement officials of the presence of an unsecured occupant of an automobile comprising:
(a) an occupant state detector for determining the presence of an unsecured individual disposed upon a car seat located within the automobile including:
(i) a latch state sensor for detecting the state of a seat belt latch of a seat belt associated with the car seat and capable of being activated by an unbuckled seat belt; and
(ii) an occupant detector for detecting the presence of a individual seated within the car seat; and
(iii) a control unit for processing signals generated by the latch state sensor and the occupant sensor, the control unit capable of determining and generating an alarm signal when during the presence of an “OCCUPANT” signal provided by the occupant detector there is lacking for at least a predetermined criteria of time a “LATCH” signal from the latch state sensor; and
(b) a power unit for supplying electrical power to the control unit.
